(19) United States
(12) Patent Application Publication
(10) Pub. No.: US 2018/0105084 A1
(43) Pub. Date: Apr. 19, 2018

(54) Hooking Structure of Seat and Method of Hooking Trim Cover in Seat

(71) Applicant: Tachi-S Co., Ltd., Tokyo (JP)

(72) Inventors: Hideo Tobata, Tokyo (JP); Takahiko Nagasawa, Tokyo (JP); Tsutomu Fujikake, Tokyo (JP)

(73) Assignee: Tachi-S Co., Ltd., Tokyo (JP)

(21) Appl. No.: 15/567,226

(22) PCT Filed: Apr. 11, 2016
(86) PCT No.: PCT/JP2016/061726

§ 371 Date: Oct. 17, 2017

(30) Foreign Application Priority Data
Apr. 24, 2015 (JP) 2015-089322

(51) Int. Cl. B60N 2/58

(52) U.S. Cl. CPC B60N 2/5825

(57) ABSTRACT

A hooking structure (10) of a seat for supporting a trim cover (7) by hooking the trim cover (7) onto a seat member (3) constituting the seat, the hooking structure (10) comprising: a linear hook member (14) used for hooking, the linear hook member (14) being arranged on a front surface side of the trim cover (7); and an anchoring member (18) which anchors the linear hook member (14) onto the seat member (3), with the linear hook member (14) being inserted in a hooking groove (11) formed in the seat member (3). An insert member (16) to be engaged with the anchoring member (18) is preferably provided inside the seat member (3).

### TECHNICAL FIELD

The present invention relates to a hooking structure of a seat and a method of hooking a trim cover in the seat.

### BACKGROUND ART

As a structure for attaching a trim cover (surface cover) to a foam cushioning material molded into a seat shape, use has been made of a hooking structure in which the cushioning material is provided with groove-shaped hooking parts and parts of the trim cover is inserted into the hooking parts so as to be fastened with the cushioning material to thereby hook the trim cover.

As an example of such hooking structure, Patent Document 1 discloses a structure in which a hook cloth (hook bag) is sewn onto a back surface of a trim cover (seat cover) and the trim cover is secured by hooking the hook cloth and a wire (seat back wire) embedded in the cushioning material using a C-ring (see Patent Document 1).

### CITATION LIST

### Patent Document

Patent Document 1: JP 5665115 B

### SUMMARY

### Technical Problem

However, in the above-mentioned hooking structure, since the hook cloth has to be sewn onto the back surface of the trim cover, efforts and costs are required for such sewing of the hook cloth.

An object of the present invention is to provide a hooking structure of a seat and a method of hooking a trim cover in the seat, which are capable of eliminating the efforts and costs required for sewing a hook cloth onto a back surface of the trim cover.

### Solution to Problem

In order to solve the above-mentioned problem, the present invention provides a hooking structure of a seat for supporting a trim cover by hooking the trim cover with respect to a seat member constituting the seat, the hooking structure comprising: a linear hook member used for hooking, the linear hook member being arranged on a front surface side of the trim cover; and an anchoring member which anchors the linear hook member onto the seat member, with the linear hook member being inserted in a hooking groove formed in the seat member.

In such hooking structure, the trim cover is inserted in the hooking groove along with the linear hook member and anchored to the seat member without providing a hook cloth therebetween. Therefore, it is possible to hook the trim cover without sewing a hook cloth on the back surface of the trim cover.

In such hooking structure, an insert member to be engaged with the anchoring member is preferably provided inside the seat member. By engaging one end of the anchoring member with the insert member, it becomes more difficult for the anchoring member to be pulled out.

It is preferable for a marking indicating a position to arrange the linear hook member to be provided on a front surface of the trim cover.

The present invention also provides a hooking method for attaching a trim cover to a seat member by hooking the trim cover in the seat member provided with a hooking groove, the method comprising: arranging a linear hook member used for hooking on a front surface side of the trim cover; wrapping the linear hook member by the front surface side of the trim cover; inserting the linear hook member which is wrapped by the trim cover along with part of the seat member in the hooking groove formed in the seat member; and anchoring the linear hook member onto the seat member by an anchoring member.

### Advantageous Effects of Invention

According to the present invention, it is possible to eliminate the efforts and costs required for sewing a hook cloth onto a back surface of a trim cover.

### BRIEF DESCRIPTION OF DRAWINGS

FIG. 1 is a perspective view showing a seat according to an embodiment of the present invention.

FIG. 2 is a perspective view showing how linear hook members are arranged in accordance with markings on a backrest (seat member).

FIG. 3 is a diagram showing an example of a cross-sectional structure of the backrest (seat member) and a hooking structure taken along line III-III in FIG. 1.

FIG. 4 is a cross-sectional view showing the backrest (seat member), etc. with a trim cover being hooked.

### DESCRIPTION OF EMBODIMENTS

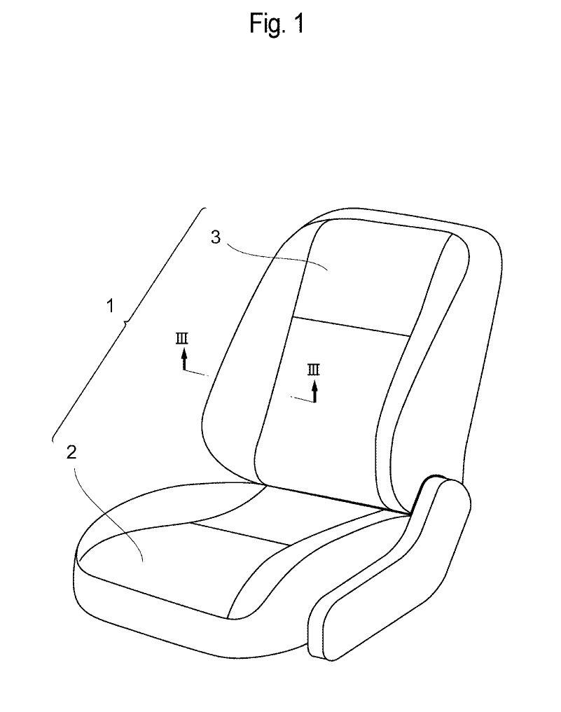

A preferred embodiment of a hooking structure for a seat and a hooking method according to the present invention will be described in detail with reference to the attached drawings (see FIGS. 1-4).

A seat 1 includes a seat face 2 that is moveable forward and rearward on a floor panel of a vehicle and a backrest 3 that is reclinable relative to the seat face 2. The seat face 2 and the backrest 3 are each a seat member constituting the seat 1 and each have a cushioning material 4 made of a foam material. A trim cover 7 can be detachably attached to the seat face 2 and the backrest 3 using a hooking structure 10.

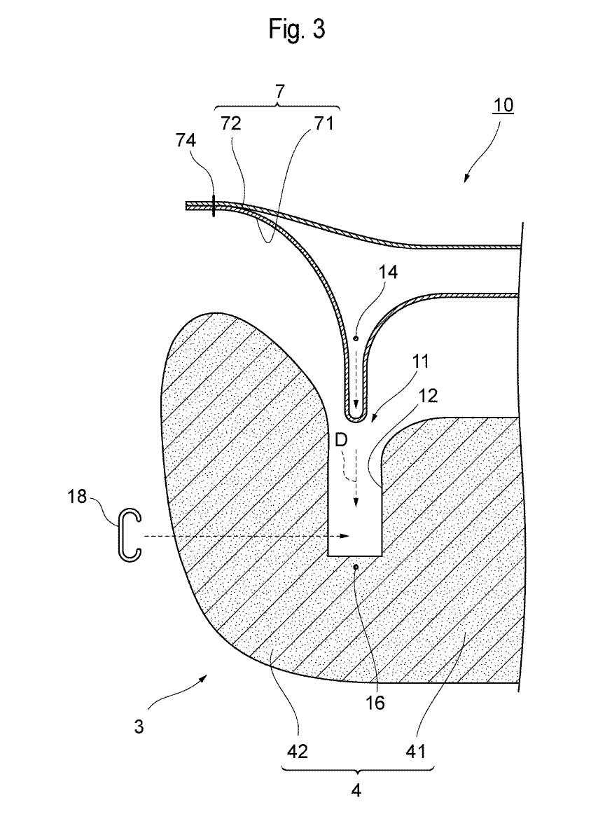

The following description will describe the backrest 3 as an example. The cushioning material 4 constituting the backrest 3 includes a main cushioning part 41 for supporting the back of an occupant from the rear side thereof and a side cushioning part 42 for holding the back of the occupant from the lateral sides thereof (see FIG. 3).

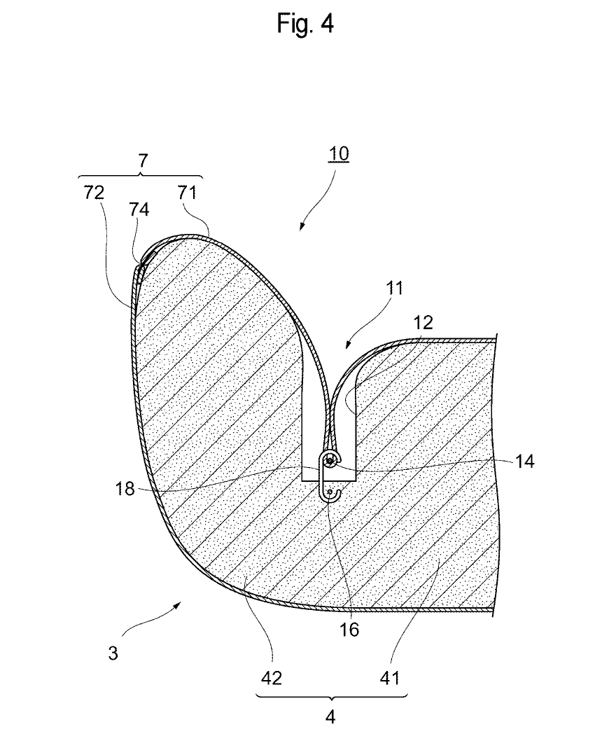

The trim cover 7 is formed by: a main face part 71 mounted on the main cushioning part 41 and part of the side cushioning part 42 of the cushioning material 4; and a side face part 72 mounted on the remainder of the side cushioning part 42. The main face part 71 and the side face part 72 of the trim cover 7 are configured such that: they are joined with each other by a sewing part 74, with their respective front surfaces being in contact with each other; and when the main face part 71 and the side face part 72 cover the cushioning material 4 with the front surfaces thereof facing the occupant and the back surfaces thereof facing the cushioning material 4, the sewing part 74 and a distal end portion, relative to the sewing part 74, of the trim cover 7 will not be exposed to the front surface side (see FIGS. 3 and 4).

Next, the hooking structure 10 will be described. The hooking structure 10 includes hooking grooves 11, linear hook members 14, insert wires 16 and hog rings 18 (see FIG. 3).

The hooking grooves 11 are each constituted by a recess 12 formed so as to have a predetermined width in the longitudinal direction of the backrest 2 along a boundary between the main cushioning part 41 and the side cushioning part 42, and the hooking groove 11 forms the exterior appearance of the seat 1. During normal time, the recess 12 is compressed and closed between the main cushioning part 41 and the side cushioning part 42 due to the elasticity of the cushioning material 4. However, FIGS. 3 and 4 show the recess 12 in an open state for ease of understanding.

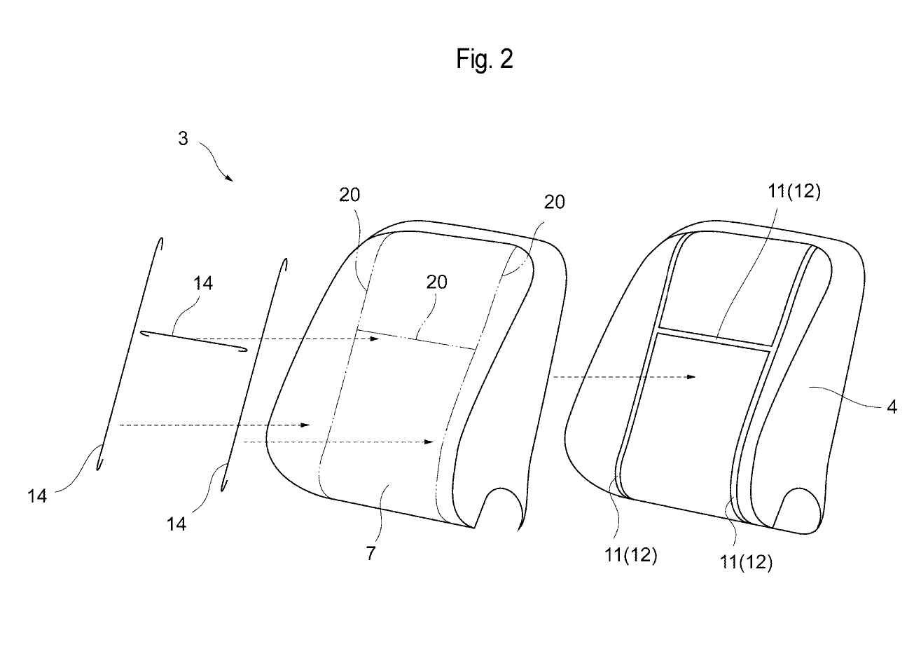

The backrest 3 is further provided with hooking grooves 11 extending along the transverse direction (the width direction of the backrest 3), in addition to the above-mentioned hooking groove 11, and the seat face 2 is also provided with hooking grooves 11 (see FIGS. 1 and 2). However, the present embodiment will be described with regard to an example of the hooking groove 11 constituted by the recess 12 formed in the longitudinal direction as described above.

The insert wires 16 are each embedded inside the cushioning material 4 of the backrest 2 at a predetermined depth from the bottom of the recess 12 (see FIG. 3; the groove depth direction of the recess 12 is denoted by reference symbol D in FIG. 3). The predetermined depth as used herein refers to a depth suitable for anchoring the linear hook member 14 and the insert wire 16 by the hog ring 18 by taking into consideration the size, etc. of the hog ring 18 (see FIG. 4).

Although the specific shape of the insert wire 16 is not shown in the drawing, the insert wire 16 may be a wire that is extended straight in a direction in which the recess 12 is formed (in the present embodiment, the longitudinal direction along the boundary between the main cushioning part 41 and the side cushioning part 42) or may be a wire wherein a portion thereof to which the hog ring 18 is anchored is cranked toward the recess 12.

The linear hook members 14 are each arranged on a front surface side (the front surface being a surface which faces opposite to the cushioning material 4 and serves as a skin that contacts with the occupant on the seat 1) of the trim cover 7. The linear hook member 14 is inserted in the hooking groove 11 along with part of the trim cover 7 so as to hook the trim cover 7. The linear hook member 14 may be made of, for example, metal such as iron or aluminum, resin such as polypropylene or polyethylene, or rubber. Both ends of the linear hook member 14 formed of a linear wire are rounded so that the linear hook member 14 becomes easily handleable and becomes difficult to move in the longitudinal direction within the hooking groove 11 (see FIG. 2).

The trim cover 7 is provided with markings 20 at predetermined positions on the front surface thereof in order to indicate positions to arrange the linear hook members 14 (see FIG. 2). By using such markings 20 as indicators, it is possible to arrange the linear hook members 14 at the predetermined positions and insert the linear hook members 14 into the hooking grooves 11 along with the trim cover 7. The markings 20 may be constituted by, for example, small holes (dots), ruled lines, etc. formed on the front surface of the trim cover 7.

The hog ring 18 anchors the linear hook member 14, which has been inserted into the hooking groove 11, to the seat member. Although not shown, the hog ring 18 can be easily anchored to a predetermined position in the hooking groove 11 using a dedicated tool (hog ring fastener). The hog ring 18 is formed in a substantially C shape, with one end thereof extending through the trim cover 7 from the back surface side thereof and hooking the linear hook member 14, and the other end thereof sticking into the cushioning material 4 and hooking the insert wire 16, the ends being compressed and deformed so as to fasten the linear hook member 14 and the insert wire 16 (see FIGS. 3 and 4).

The following description will briefly describe an operation for hooking the trim cover 7 using the above-mentioned hooking structure 10.

First, the linear hook member 14 is arranged at a predetermined position on the front surface side of the trim cover 7 using the marking 20 as an indicator (see FIGS. 2 and 3). The linear hook member 14 is then inserted into the hooking groove 11 while being wrapped by the trim cover 7 (see FIG. 3).

Next, the linear hook member 14 and the insert wire 16 are fastened by the hog ring 18 using a hog ring fastener (not shown) (see FIGS. 3 and 4). In the same way, the linear hook members 14 and the insert wires 16 are fastened by the respective hog rings 18 at the other predetermined positions. With the above-mentioned operation steps, the linear hook members 14 along with parts of the trim cover 7 are anchored to the backrest 3 and the hooking operation is terminated.

According to the hooking structure 10 described above, part of the trim cover 7 can be inserted into the hooking groove 11 along with the linear hook member 14 and anchored to the cushioning material 4 without using a hook cloth (hook bag). In other words, since the trim cover 7 can be hooked without sewing the hook cloth onto the back surface of the trim cover 7, it is possible to eliminate the costs and efforts required for sewing the hook cloth as in conventional hooking structures.

In order to detach the trim cover 7 from the cushioning material 4, the trim cover 7 inserted in the hooking groove 11 is pulled so that the hog ring 18, which has been engaged with the linear hook member 14 and the insert wire 16, is deformed so as to cancel the fastened state.

It should be noted that the above-described embodiment is merely an example of a preferred embodiment of the present invention, and the present invention is not limited thereto and various modifications can be made thereto without departing from the gist of the present invention. For example, the seat 1 according to the present invention 1 may be utilized as an aircraft seat, passenger ship seat, etc., in addition to an automobile seat.

Although the provision of the insert member, such as the insert wire 16, in the cushioning material 4, as in the embodiment described above, is preferable in that it is capable of relaxing a localized deformation of the cushioning material 4 and making it difficult to move or pull out the hog ring 18, it is not necessary for the insert member to be provided as long as the hog ring 18 can be rigidly anchored by the cushioning material 4 alone.

The above-mentioned hog ring 18 is merely a preferred example of an anchoring member for fastening the linear hook member 14 and the insert wire 16, and other C-shape rings or a variety of other anchoring members may be used.

### INDUSTRIAL APPLICABILITY

The present invention is suitably applicable to a hooking structure of a seat which allows a trim cover to be supported onto seat members constituting the seat.

### REFERENCE SIGNS LIST

1: seat
2: seat face (seat member)
3: backrest (seat member)
4: cushioning material
7: trim cover
10: hooking structure
11: hooking groove (groove for hooking)
14: linear hook member
16: insert wire (insert member)
18: hog ring (anchoring member)
20: marking

1. A hooking structure of a seat for supporting a trim cover by hooking the trim cover with respect to a seat member constituting the seat, the hooking structure comprising:
a linear hook member used for hooking, the linear hook member being arranged on a front surface side of the trim cover; and
an anchoring member which anchors the linear hook member onto the seat member, with the linear hook member being inserted in a hooking groove formed in the seat member.

2. The hooking structure according to claim 1, wherein an insert member to be engaged with the anchoring member is provided inside the seat member.

3. The hooking structure according to claim 1 or 2, wherein a marking indicating a position to arrange the linear hook member is provided on a front surface of the trim cover.

4. A hooking method for attaching a trim cover to a seat member by hooking the trim cover in the seat member provided with a hooking groove, the method comprising:
arranging a linear hook member used for hooking on a front surface side of the trim cover;
wrapping the linear hook member by the front surface side of the trim cover;
inserting the linear hook member which is wrapped by the trim cover along with part of the seat member in the hooking groove formed in the seat member; and
anchoring the linear hook member onto the seat member by an anchoring member.

5. The hooking structure according to claim 2, wherein a marking indicating a position to arrange the linear hook member is provided on a front surface of the trim cover.
